(19) United States
(12) Patent Application Publication
(10) Pub. No.: US 2013/0194315 A1
(43) Pub. Date: Aug. 1, 2013

(54) GAMUT CONTROL USING RGB DRIVING WITH ADDITIONAL BALANCING PHASE FOR FIELD SEQUENTIAL COLOR DISPLAYS AND OTHER DISPLAYS

(71) Applicant: Vladimir Trondin, Oulu (FI)

(72) Inventor: Vladimir Trondin, Oulu (FI)

(73) Assignee: TEXAS INSTRUMENTS INCORPORATED, Dallas, TX (US)

(21) Appl. No.: 13/360,466

(22) Filed: Jan. 27, 2012

(51) Int. Cl. G09G 5/10

(52) U.S. Cl. 345/690

(57) ABSTRACT

A system includes multiple light emitting diodes (LEDs), where different LEDs are configured to generate light of different individual colors. The system also includes a display driver configured to generate drive signals for driving the LEDs. The display driver is configured in different phases of a repeating frame to activate different ones of the LEDs in order to generate the different individual colors of light. The display driver is also configured in a balancing phase of the repeating frame to activate two or more of the LEDs in order to generate a non-white color of light. The non-white color of light comprising a combination of at least two of the different individual colors of light.

### TECHNICAL FIELD

This disclosure relates generally to display drivers and display devices. More specifically, this disclosure relates to gamut control using red-green-blue (RGB) driving with an additional balancing phase for field sequential color displays and other displays.

### BACKGROUND

The gamut of a graphical display defines the subset of colors that can be reproduced accurately by the display device. The subset of colors is said to fall within a color space. Field sequential color (FSC) displays typically operate by generating different colors of light at different times. For example, light emitting diodes (LEDs) can generate red, green, and blue light at different times during repeating frames. However, using pure LED illumination often produces images that do not look natural as the resulting color space typically does not match any standard color space (such as an sRGB, NTSC, or ADOBE RGB standard color space). Also, using pure LED illumination can lead to color breakup, which means some viewers may be able to perceive the individual color components.

One approach to solving these problems is to use red-green-blue-green (RGBG) or red-green-blue-white (RGBW) illumination. Here, green or white light is generated during a fourth phase of each frame. However, while RGBG illumination helps to reduce color breakup, the color space remains the same as with pure RGB illumination. Also, while RGBW illumination helps to reduce color breakup and allows the color space to be adjusted, the color space can only be contracted or shrunk, and the resulting color space is often not close to a standard color space.

### BRIEF DESCRIPTION OF DRAWINGS

For a more complete understanding of this disclosure and its features, reference is now made to the following description, taken in conjunction with the accompanying drawings, in which:

FIG. 1 illustrates an example graphical display driver according to this disclosure;

FIG. 2 illustrates example drive signals supporting red-green-blue (RGB) driving with an additional balancing phase in a graphical display driver according to this disclosure;

FIG. 3 illustrates example temperature compensation curves in a graphical display driver according to this disclosure;

FIGS. 4A and 4B illustrate example color spaces in graphical display drivers according to this disclosure; and

FIG. 5 illustrates an example method for driving a graphical display using RGB driving with an additional balancing phase according to this disclosure.

### DETAILED DESCRIPTION

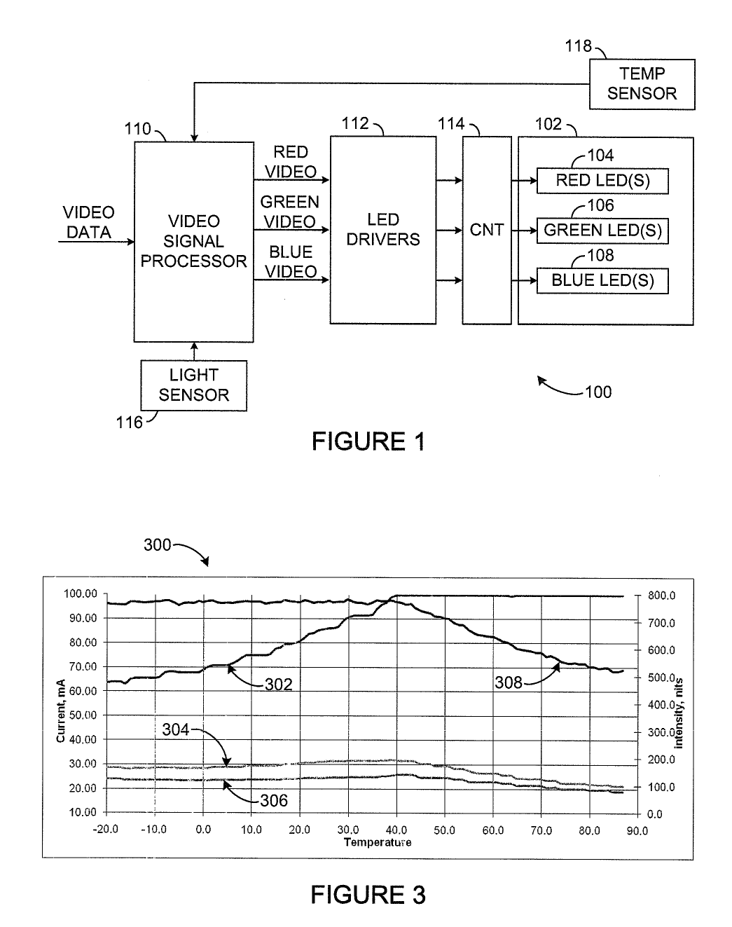

FIG. 1 through 5, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

FIG. 1 illustrates an example graphical display driver 100 according to this disclosure. As shown in FIG. 1, the driver 100 includes, is coupled to, or is otherwise associated with a graphical display 102. The graphical display 102 represents any suitable structure for presenting graphical images. The graphical display 102 here includes multiple light emitting diodes (LEDs) 104-108, namely one or more red LEDs 104, one or more green LEDs 106, and one or more blue LEDs 108. Each LED 104-108 includes any suitable semiconductor structure that generates light. Note that any number of LEDs for each color could be used. Also note that the graphical display 102 could form part of any larger device or system. For instance, the graphical display 102 could form part of a television, computer monitor, laptop computer display, mobile telephone, personal digital assistant, or other fixed or portable device.

As shown in FIG. 1, the driver 100 includes a video signal processor 110, which receives video data from any suitable source. The video signal processor 110 processes the video data to generate red, green, and blue output video data. The video signal processor 110 could perform any suitable processing operations, such as warping, frame rate conversion, and video correction. The video signal processor 110 includes any suitable structure for processing video data. For instance, the video signal processor 110 could include at least one processor, microprocessor, microcontroller, digital signal processor (DSP), application specific integrated circuit (ASIC), field programmable gate array (FPGA), or other computing or processing device(s).

The output video data is provided to one or more LED drivers 112, which generate drive signals for driving the LEDs 104-108. For example, the LED driver(s) 112 could convert the red, green, and blue output video data into LED control voltages and control currents that control the light generated by the LEDs 104-108. Each LED driver 112 includes any suitable structure for driving one or more LEDs. In some embodiments, multiple LED drivers 112 are used, such as one for each LED color. In particular embodiments, LP8545 or LP8547 LED drivers from TEXAS INSTRUMENTS INCORPORATED could be used.

The drive signals from the LED driver(s) 112 are provided to the LEDs 104-108 via at least one connector (CNT) 114. Each connector 114 represents any suitable structure for coupling an LED driver to one or more LEDs. In some embodiments, the LEDs 104-108 are arranged within an LED light bar, and the connector 114 represents an LED bar connector.

One or more sensors could also be used to adjust the driving of the LEDs 104-108. For example, a light sensor 116 could be used to measure an amount of ambient light around the graphical display 102. The video signal processor 110 could then drive the LEDs 104-108 to be brighter or dimmer depending on the amount of measured light. As another example, the luminous intensity of an LED typically varies based on temperature, and different LEDs can respond differently to temperature changes. A temperature sensor 118 could be used to measure the temperature of the graphical display 102 or its LEDs 104-108. The drive signal(s) for the LED(s) 104-108 could then be adjusted depending on the measured temperature. Each sensor 116-118 includes any suitable structure for measuring one or more characteristics associated with the graphical display driver 100 or the graphical display 102.

As described in more detail below, the LEDs 104-108 can be turned on at different times during repeating frames. For example, the red LED(s) 104 could be turned on during a first phase of a frame, the green LED(s) 106 could be turned on during a second phase of the frame, and the blue LED(s) 108 could be turned on during a third phase of the frame. Moreover, during at least one additional “balancing” phase of the frame, the LEDs 104-108 can be driven together to generate a non-white “balancing” color point. Among other things, the use of a non-white balancing color point during an additional illumination phase in a frame can help to reduce color breakup while allowing the color space to be adjusted. Further, the driving of the LEDs 104-108 can be adjusted so that the overall illumination generated during all phases of a frame still achieves a target brightness and a target white color point. In addition, the same image displayed during the red, green, and blue phases can be displayed during the additional balancing phase(s), allowing the same color-related image to be presented multiple times per frame.

In this way, the gamut of a field sequential color (FSC) display or other display can be adjusted more accurately. For instance, the gamut of a display could be adjusted so that its color space equals or substantially approximates a standard color space. Moreover, this approach helps to reduce or eliminate color breakup. In addition, depending on the implementation, an algorithm for implementing color space adjustments using this technique can be less complex and simpler to implement compared to other techniques for color space adjustment.

Note that the additional balancing phase(s) of a frame may involve the generation of any suitable color of light. For example, the color of light can be selected so that the balancing color point created during a balancing phase modifies a color space to achieve a desired gamut. Note that, if desired, the balancing phase can be used in some but not all frames of video data.

Although FIG. 1 illustrates one example of a graphical display driver 100, various changes may be made to FIG. 1. For example, the display driver 100 could include or be used with any number of each component shown in FIG. 1. Also, FIG. 1 illustrates one example operational environment where a non-white balancing color point can be used in an additional phase of a video frame. This technique could be used with any suitable device or system.

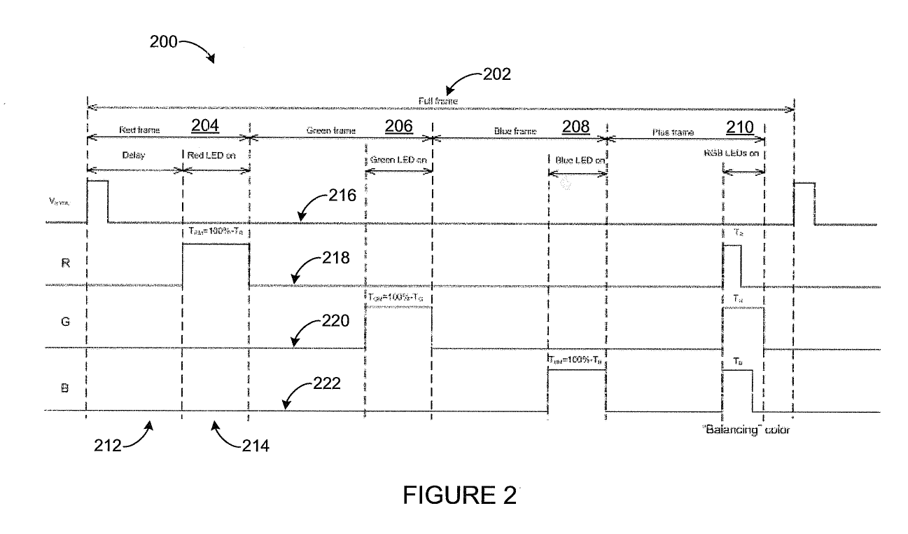

FIG. 2 illustrates example drive signals 200 supporting RGB driving with an additional balancing phase in a graphical display driver according to this disclosure. For ease of explanation, the drive signals 200 are described with respect to the graphical display driver 100 of FIG. 1. The drive signals 200 could be used by any other suitable graphical display driver, and the graphical display driver 100 of FIG. 1 could operate using other drive signals.

As shown in FIG. 2, a frame 202 is divided into multiple sub-frames or phases 204-210. In this example, the phase 204 represents a red sub-frame in which red light is generated for a graphical display. The phase 206 represents a green sub-frame in which green light is generated for the graphical display. The phase 208 represents a blue sub-frame in which blue light is generated for the graphical display. The phase 210 represents a balancing sub-frame in which red, green, and blue light can be generated for the graphical display.

Each phase 204-210 is divided here into a delay stage 212 and an LED activation stage 214. Each delay stage 212 represents a period of time where no LEDs are being activated. Each LED activation stage 214 represents a period of time where at least one LED is being driven. Each state 212-214 could represent any suitable length of time, and the lengths of time need not be the same between phases 204-210 or between frames 202.

In FIG. 2, pulses in a V_{SYNC} signal 216 denote the beginning of different frames 202. Pulses in a red drive signal 218 denote the periods of time when one or more red LEDs 104 are being driven. Pulses in a green drive signal 220 denote the periods of time when one or more green LEDs 106 are being driven. Pulses in a blue drive signal 222 denote the periods of time when one or more blue LEDs 108 are being driven.

As shown in FIG. 2, one or more LEDs of a single color are driven during each of the phases 204-208. In the balancing phase 210, however, LEDs of different colors (three colors in this case) are driven during the LED activation stage 214 of that phase 210.

Since the LEDs 104-108 are being driven in multiple phases, the total amount of time that each LED 104-108 needs to be driven can be split between multiple phases. For example, the combined lengths of the pulses in the red drive signal 218 during the phases 204 and 210 collectively cause the red LED(s) 104 to generate the desired amount of red light for a desired display brightness. Similarly, the combined lengths of the pulses in the green drive signal 220 during the phases 206 and 210 collectively cause the green LED(s) 106 to generate the desired amount of green light for the desired display brightness. Finally, the combined lengths of the pulses in the blue drive signal 222 during the phases 208 and 210 collectively cause the blue LED(s) 108 to generate the desired amount of blue light for the desired display brightness. In this way, the display driver 100 is able to drive the LEDs 104-108 during multiple phases of a frame 202 without significantly changing the target brightness or the target white color point.

Note here that the LED activation stages 214 in the phases 204-210 need not be equal in length (although a common maximum permitted length could be used). Instead, the LEDs 104-108 could be driven for different lengths of time in the phases 204-210, depending on how much of each color light is currently needed by the graphical display 102. Also, the specific amounts of time that the different LEDs are driven in the balancing phase 210 can depend on various factors. For example, the lengths of time that the LEDs 104-108 are driven in the balancing phase 210 depends on the specific modification that is being made to the color space of a graphical display. The balancing color point generated using the LEDs 104-108 in the balancing phase 210 could represent any suitable color, and the balancing color point can change depending on various factors, such as the age of the display. Other factors could include the temperature of the display or the ambient light around the display. In addition, other forms of compensation could also be performed that modify the pulses in the drive signals, such as LED bin compensation.

Although FIG. 2 illustrates examples of drive signals 200 supporting RGB driving with an additional balancing phase in a graphical display driver, various changes may be made to FIG. 2. For example, each drive signal 218-222 could include any number of pulses in the relevant LED activation stages.

FIG. 3 illustrates example temperature compensation curves 300 in a graphical display driver according to this disclosure. For ease of explanation, the compensation curves 300 are described with respect to the graphical display driver 100 of FIG. 1. The compensation curves 300 could be used by any other suitable graphical display driver, and the graphical display driver 100 of FIG. 1 could operate using other compensation curves.

As noted above, the luminous intensity of an LED typically varies based on temperature, and different LEDs can respond differently to temperature changes. In FIG. 3, curves 302-306 respectively identify how particular red, green, and blue LEDs respond to changes in temperature. In particular, the compensation curves 302-306 denote how currents through the red, green, and blue LEDs need to vary as temperature increases in order to obtain maximum brightness (a 100% duty cycle).

The line 302 is associated with an example red LED and indicates that a drive signal needs to increase from about 63 mA to about 100 mA to maintain maximum brightness as the LED temperature increases from about −20° C. to about +39° C. The line 304 is associated with an example green LED and indicates that a drive signal needs to increase from about 28 mA to about 32 mA to maintain maximum brightness as the LED temperature increases from about −20° C. to about +39° C. The line 306 is associated with an example blue LED and indicates that a drive signal can stay generally around about 25 mA-26 mA to maintain maximum brightness as the LED temperature increases from about −20° C. to about +39° C.

A line 308 in FIG. 3 represents how the overall intensity of the LEDs varies with temperature. As shown here, the luminous intensities of the LEDs drop as the temperature increases above about +39° C. In this example, less current is needed in the green and blue LEDs as their intensities drop, while generally the same amount of current is needed in the red LEDs as their intensities drop.

Using the compensation curves 302-306, a component can modify the signals used to drive the LEDs 104-108. For example, the video signal processor 110 could receive measured temperatures from the temperature sensor 118 and determine how to modify the output video data so that the LEDs 104-108 are driven with the appropriate currents. This helps the display driver 100 to drive the LEDs 104-108 in a manner that creates the appropriate intensities of different colored light. In particular embodiments, the video signal processor 110 could use a look-up table for each color, where the look-up table associates different currents with different temperatures.

Although FIG. 3 illustrates examples of temperature compensation curves 300 in a graphical display driver, various changes may be made to FIG. 3. For example, these compensation curves 300 are related to specific LEDs. Other LEDs could be associated with other compensation curves.

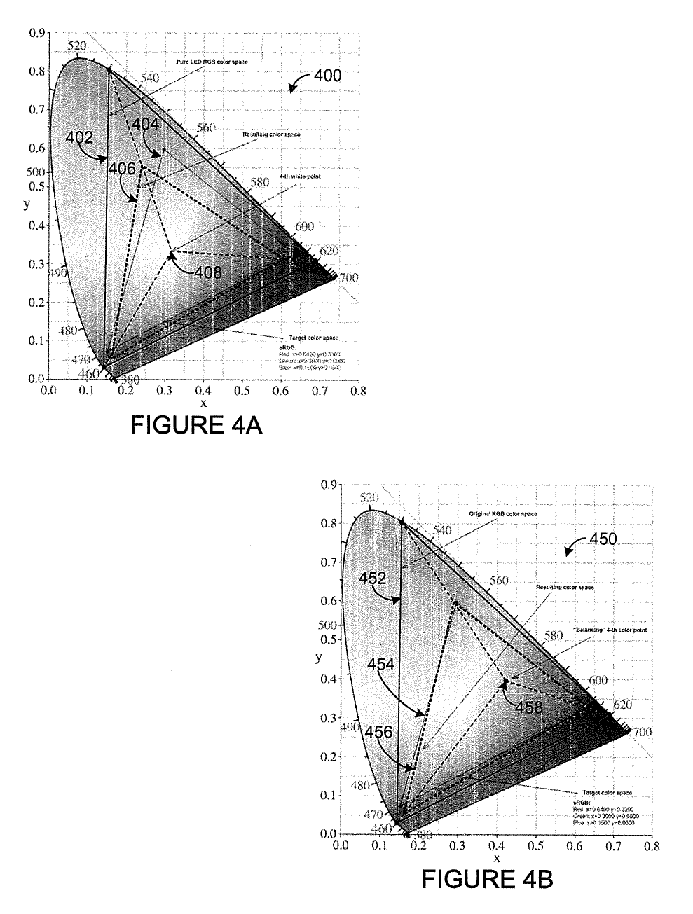

FIGS. 4A and 4B illustrate example color spaces in graphical display drivers according to this disclosure. In particular, FIG. 4A illustrates an example color space 400 associated with a conventional RGBW illumination technique, while FIG. 4B illustrates an example color space 450 associated with the display driver 100 of FIG. 1.

As shown in FIG. 4A, a triangle 402 represents an overall color space that might be obtainable using pure LED illumination with red, green, and blue LEDs. A triangle 404 represents a target color space that is associated with a particular standard, in this case the sRGB standard. As shown here, the triangle 404 falls completely within the triangle 402, which indicates that the sRGB standard color space can be achieved using pure LED illumination. However, a triangle 406 represents a color space that is achieved using standard RGBW illumination.

As can be seen in FIG. 4A, the triangle 406 differs significantly from the triangle 404. This indicates that the color space obtained using RGBW illumination does not closely match the standard sRGB color space. The reason for this discrepancy is that a white light point 408 associated with pure white light is used as the balancing color, which causes the gamut of a display to move away from the standard color space (triangle 404) to the modified color space (triangle 406). As a result, images created using RGBW illumination may appear unnatural.

As shown in FIG. 4B, a triangle 452 represents the overall color space obtainable using pure LED illumination with red, green, and blue LEDs. A triangle 454 represents a target color space associated with the sRGB standard. A triangle 456 represents a color space that could be achieved using the display driver 100 shown in FIG. 1.

As can be seen in FIG. 4B, the triangle 456 closely matches the triangle 454. This indicates that the color space obtained using the display driver 100 of FIG. 1 closely matches the standard sRGB color space. This causes the gamut of a display to approximate the standard color space, so images created in this manner may appear more natural. This is accomplished since a balancing color point 458 is a non-white color that can be selected to make suitable adjustments to the color space. Moreover, this approach helps to reduce or eliminate color breakup by increasing the number of phases during which light is generated.

Although FIGS. 4A and 4B illustrate examples of color spaces in graphical display drivers, various changes may be made to FIGS. 4A and 4B. For example, the display driver 100 of FIG. 1 could have any other suitable color space, such as a color space associated with a different balancing color point or a color space that equals or approximates a different standard.

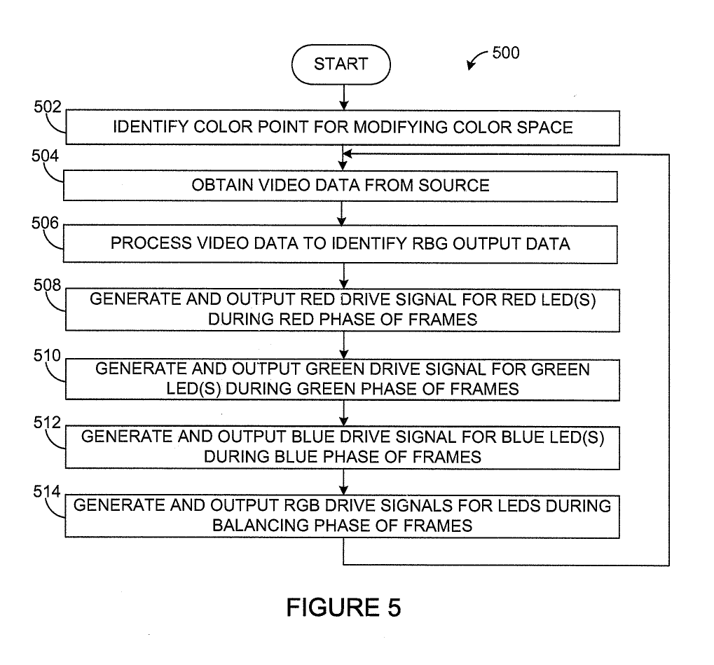

FIG. 5 illustrates an example method 500 for driving a graphical display using RGB driving with an additional balancing phase according to this disclosure. As shown in FIG. 5, a balancing color point for modifying the color space of a display is identified at step 502. The balancing color point can be identified in any suitable manner. For instance, this can be done by taking the existing color space of a display and identifying the balancing color point needed to modify the color space so that it matches or approximates a standard color space.

Video data is obtained from a source at step 504. This could include, for example, receiving video data from an optical disc, hard disk, communication link, or any other suitable source. The video data is processed to identify RGB output data at step 506. This could include, for example, the video signal processor 110 performing warping, frame rate conversion, video correction, or other processing operations to generate red, green, and blue output video data.

A red drive signal for one or more red LEDs is generated and output during a red phase of repeating frames at step 508. A green drive signal for one or more green LEDs is generated and output during a green phase of repeating frames at step 510. A blue drive signal for one or more blue LEDs is generated and output during a blue phase of repeating frames at step 512. Red, green, and blue drive signals for the LEDs are generated and output during a balancing phase of repeating frames at step 514. These steps could include, for example, the LED driver(s) 112 generating drive signals during the phases 204-210 of each frame 202. As noted above, each color LED is collectively driven by a desired amount in multiple phases of each frame to help ensure that a target brightness and a target white color point are obtained.

Although FIG. 5 illustrates one example of a method 500 for driving a graphical display using RGB driving with an additional balancing phase, various changes may be made to FIG. 5. For example, while shown as a series of steps, various steps in FIG. 5 could overlap, occur in parallel, occur in a different order, or occur any number of times.

It may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
multiple light emitting diodes (LEDs), different LEDs configured to generate light of different individual colors; and
a display driver configured to generate drive signals for driving the LEDs;
wherein the display driver is configured in different phases of a repeating frame to activate different ones of the LEDs in order to generate the different individual colors of light; and
wherein the display driver is configured in a balancing phase of the repeating frame to activate two or more of the LEDs in order to generate a non-white color of light, the non-white color of light comprising a combination of at least two of the different individual colors of light.

2. The system of claim 1, wherein the LEDs comprise one or more red LEDs, one or more green LEDs, and one or more blue LEDs.

3. The system of claim 2, wherein the display driver is configured to:
generate a first drive signal for activating the one or more red LEDs during a first phase of the repeating frame;
generate a second drive signal for activating the one or more green LEDs during a second phase of the repeating frame; and
generate a third drive signal for activating the one or more blue LEDs during a third phase of the repeating frame.

4. The system of claim 3, wherein the display driver is configured to generate the first, second, and third drive signals to activate the red, green, and blue LEDs during the balancing phase of the repeating frame.

5. The system of claim 1, wherein:
the LEDs are associated with a graphical display; and
the display driver is configured to drive the LEDs so that a gamut associated with the graphical display has a color space that equals or substantially approximates a standard color space.

6. The system of claim 1, wherein the display driver comprises:
a video signal processor configured to receive video data and to output red, green, and blue output video data; and
one or more LED drivers configured to activate the LEDs based on the red, green, and blue output video data.

7. The system of claim 1, further comprising:
a temperature sensor configured to measure a temperature of the LEDs;
wherein the display driver is configured to use one or more compensation curves to drive the LEDs, the one or more compensation curves associating LED intensity and LED temperature.

8. The system of claim 1, wherein pulses in the drive signals collectively activate the LEDs to generate light at a desired brightness and a desired white color point during each frame.

9. An apparatus comprising:
a display driver configured to generate drive signals for driving multiple LEDs;
wherein the display driver is configured in different phases of a repeating frame to activate different ones of the LEDs in order to generate different individual colors of light; and
wherein the display driver is configured in a balancing phase of the repeating frame to activate two or more of the LEDs in order to generate a non-white color of light, the non-white color of light comprising a combination of at least two of the different individual colors of light.

10. The apparatus of claim 9, wherein the display driver is configured to generate the drive signals for activating one or more red LEDs, one or more green LEDs, and one or more blue LEDs.

11. The apparatus of claim 10, wherein the display driver is configured to:
generate a first drive signal for activating the one or more red LEDs during a first phase of the repeating frame;
generate a second drive signal for activating the one or more green LEDs during a second phase of the repeating frame; and
generate a third drive signal for activating the one or more blue LEDs during a third phase of the repeating frame.

12. The apparatus of claim 11, wherein the display driver is configured to generate the first, second, and third drive signals to activate the red, green, and blue LEDs during the balancing phase of the repeating frame.

13. The apparatus of claim 9, wherein the display driver is configured to drive the LEDs so that a gamut associated with a graphical display has a color space that equals or substantially approximates a standard color space.

14. The apparatus of claim 9, wherein the display driver comprises:
a video signal processor configured to receive video data and to output red, green, and blue output video data; and
one or more LED drivers configured to activate the LEDs based on the red, green, and blue output video data.

15. The apparatus of claim 9, wherein:
the display driver is configured to receive a measurement of a temperature of the LEDs; and
the display driver is configured to use one or more compensation curves to drive the LEDs, the one or more compensation curves associating LED intensity and LED temperature.

16. The apparatus of claim 9, wherein pulses in the drive signals collectively activate the LEDs to generate light at a desired brightness and a desired white color point during each frame.

17. A method comprising:
generating drive signals for driving multiple light emitting diodes (LEDs), different LEDs configured to generate light of different individual colors;
in different phases of a repeating frame, activating different ones of the LEDs in order to generate the different individual colors of light; and
in a balancing phase of the repeating frame, activating two or more of the LEDs in order to generate a non-white color of light, the non-white color of light comprising a combination of at least two of the different individual colors of light.

18. The method of claim 17, wherein:
the LEDs comprise one or more red LEDs, one or more green LEDs, and one or more blue LEDs; and
generating the drive signals comprises:
generating a first drive signal for activating the one or more red LEDs during a first phase of the repeating frame;
generating a second drive signal for activating the one or more green LEDs during a second phase of the repeating frame; and
generating a third drive signal for activating the one or more blue LEDs during a third phase of the repeating frame.

19. The method of claim 18, wherein generating the drive signals further comprises generating the first, second, and third drive signals for activating the red, green, and blue LEDs during the balancing phase of the repeating frame.

20. The method of claim 17, wherein:
the LEDs are associated with a graphical display; and
the method further comprises driving the LEDs so that a gamut associated with the graphical display has a color space that equals or substantially approximates a standard color space.
